(19) United States
(12) Patent Application Publication
(10) Pub. No.: US 2018/0361281 A1
(43) Pub. Date: Dec. 20, 2018

(54) A Dewatering Device and a Tensioning Apparatus for a Belt Conveyor

(71) Applicant: HYDRO INTERNATIONAL LIMITED, Clevedon (GB)

(72) Inventor: David Bernard Bogardus, Scottsdale, AZ (US)

(21) Appl. No.: 16/060,379

(22) PCT Filed: Dec. 12, 2016
(86) PCT No.: PCT/GB2016/053920

§ 371 Date: Jun. 7, 2018

Related U.S. Application Data
(60) Provisional application No. 62/265,855, filed on Dec. 10, 2015.

(51) Int. Cl. B01D 33/04; B01D 33/76; B01D 33/80; B65G 23/44

(52) U.S. Cl. CPC B01D 33/04; B01D 33/76; B30B 9/127; B65G 23/44; B01D 33/80

(57) ABSTRACT

A tensioning apparatus including
first and second take-up devices configured to engage opposing ends of a roller of the belt conveyor, wherein each take-up device,
   a linear guide including a rod and a bearing which slidably supports the rod for linear movement of the rod relative to the bearing, wherein the rod includes a mounting bracket at or towards its distal end for connecting to a shaft of the roller; and
   a linear actuator comprising: a stationary part coupled to and stationary with respect to the bearing of the linear guide, a moving part coupled to the mounting bracket of the linear guide, and drive means for moving the moving part relative to the stationary part such that the rod of the linear guide slides relative to the bearing.

### TECHNICAL FIELD

The invention relates to a dewatering device, and more particularly relates to a dewatering device and a tensioning apparatus for a belt conveyor which both may form part of a wastewater screening apparatus.

### BACKGROUND

Wastewater screening apparatus are known which separate solid material from wastewater and also compact the solid material for disposal. Such apparatus may be used, for example, to remove solids from a flow of sewage so that the water from the sewage can proceed to further treatment prior to discharge or reuse. The separated solids may be disposed of in landfill.

An example of such a screening apparatus is described in U.S. Pat. No. 8,302,780. U.S. Pat. No. 8,302,780 describes a screening apparatus which uses a continuous filter belt to filter solid material from an aqueous mixture. The filtered solid material is removed from the filter belt and is passed to a dewatering device in the form of a screw press which mechanically extracts liquid from the solid material through compaction.

Although the above-referenced prior art screening apparatus is able to remove a significant amount of water from the solids, water still remains trapped therewithin. Accordingly, it is desirable to improve the dewatering process so as to produce solids with a lower water content.

Additionally, the installation and maintenance of the filter belt can be difficult and time-consuming. It is therefore also desirable to address this issue.

### SUMMARY

In accordance with an aspect there is provided a tensioning apparatus for a belt conveyor, the tensioning apparatus comprising:
first and second take-up devices configured to engage opposing ends of a roller of the belt conveyor, wherein each take-up device comprises:
a linear guide comprising a rod and a bearing which slidably supports the rod for linear movement of the rod relative to the bearing, wherein the rod comprises a mounting bracket at or towards its distal end for connecting to a shaft of the roller; and
a linear actuator comprising: a stationary part coupled to and stationary with respect to the bearing of the linear guide, a moving part coupled to the mounting bracket of the linear guide, and drive means for moving the moving part relative to the stationary part such that the rod of the linear guide slides relative to the bearing.

The mounting bracket may be a pillow block bearing which is configured to rotatably support the roller.

The linear actuator may be a screw-driven actuator.

The linear actuator and/or linear guide may comprise a measurement scale for determining the position of the roller.

The linear guide may support the shaft of the roller in a cantilevered manner.

### BRIEF DESCRIPTION OF THE DRAWINGS

For a better understanding of the invention, and to show more clearly how it may be carried into effect, reference will now be made, by way of example, to the accompanying drawings, in which:

FIG. 1 is a front perspective view of a prior art wastewater screening apparatus;

FIG. 2A is a side sectional view of the apparatus of FIG. 1;

FIG. 2B is a partial sectional view of a lower portion of a conveyor belt thereof;

FIG. 3 is a front sectional view of the apparatus of FIG. 1;

FIG. 4 is a rear sectional view of the apparatus of FIG. 1;

FIG. 5 is a perspective view of a filter belt comprising a tensioning apparatus according to an embodiment of the invention;

FIG. 6 is a side view of the filter belt showing the tensioning apparatus;

FIG. 7 is a rear section view of a wastewater screening apparatus having a dewatering device according to an embodiment of the invention;

FIG. 8 is a perspective view of an auger screw of the dewatering device;

FIG. 9 is a top sectional view showing the dewatering device; and

FIG. 10 is a front sectional view showing the dewatering device.

### DETAILED DESCRIPTION

The presently described apparatus processes wastewater to extract most of the water content leaving a semi-dry organic cake which has value in post processes. The process receives the wastewater, referred to as “dirty water” and first filters it to remove most of the liquid content and then compresses the remaining cake to extract most of the remaining water. The filtration step uses a fine mesh continuous conveyor belt filter cloth to capture solids and then an auger drive to press most of the remaining water out of the cake. A wash spray is directed on the back of the filter which not only washes away debris that is attached on the outside of the filter cloth, but also clears debris normally clogged within pores of the filter cloth. In the auguring step, the cake and debris is compressed, which squeezes out the remaining dirty water and the wash water. A free water drain is located at one end of an auger channel while the cake/debris are compressed and moved by the auger screw within the auger channel in the opposite direction.

The debris captured by the filter cloth is driven downwardly into an open collection chamber which delivers the debris into the auger screw which conveys the debris to a compression chamber. Wash water that is not absorbed in the debris is free to flow above and around the auger's flights and by gravity flows toward and into the free water drain. The free water drain is located in an enclosed obstructed location so that only overflow liquid is able to freely flow into the drain. By allowing this drainage, a liquid level in the collection chamber is controlled and the dewatering drain located under the dewatering section is able to drain the remainder of water absorbed in the solid debris so that the solids debris that exits the device can meet a specified moisture content.

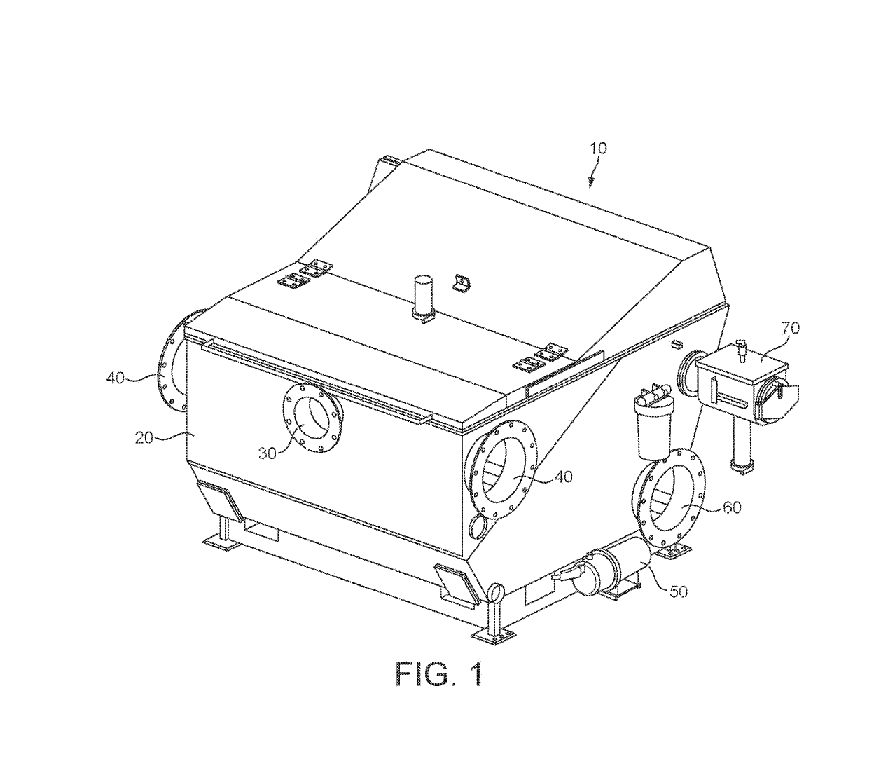

FIG. 1 illustrates a prior art industrial separator and dewatering plant 10 used for processing wastewater 15A. Components of plant 10 are supported within and attached externally to a structural enclosure 20. Locations of a plant inlet 30 for receiving the wastewater 15A, wastewater overflow outlets 40, a wash water pump 50, an outlet 60 for filtered water 15B, and a dewatering device 70 are shown. Techniques for joining in-feed and out-feed conduits to elements 30, 40 and 60 are well known in the art.

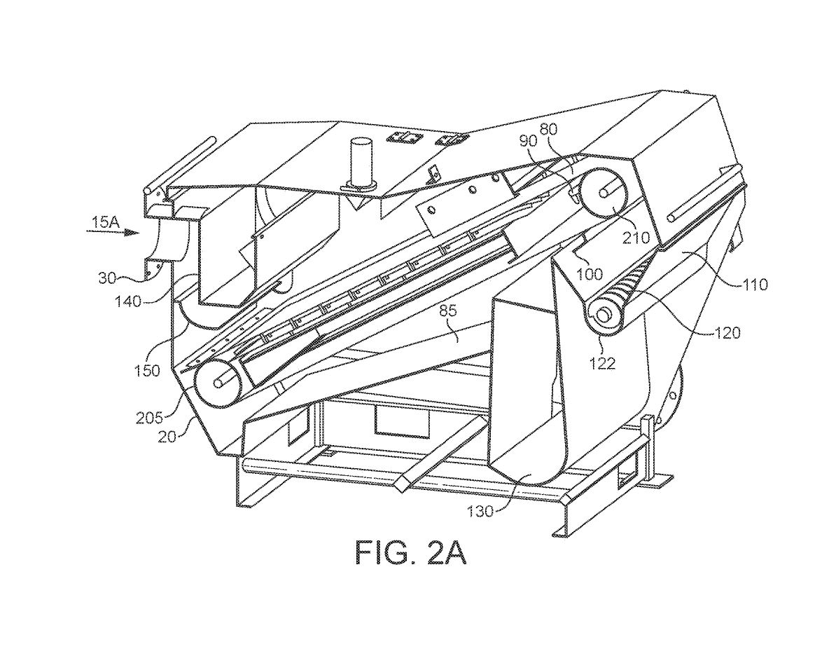

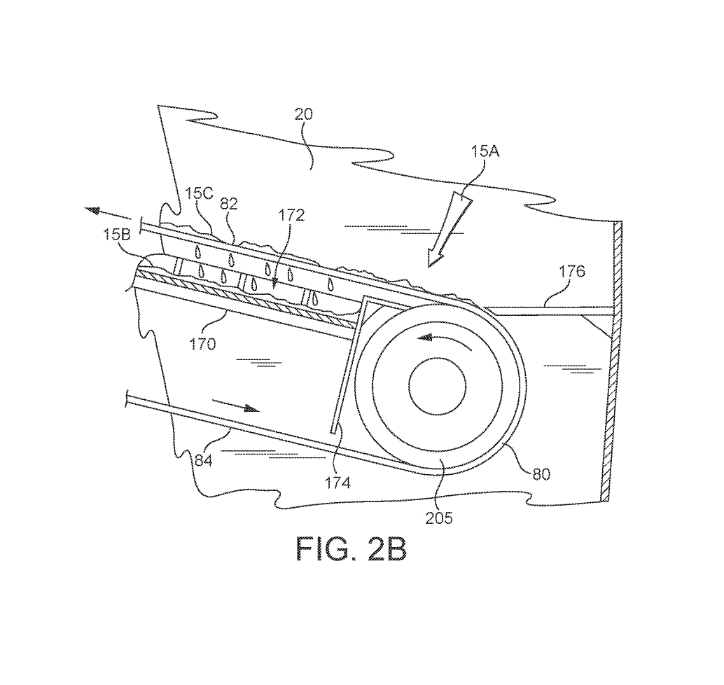

FIG. 2A shows locations of a conveyor belt 80 supported by bottom 205 and top 210 rollers, belt 80 being a fine mesh filter which has an upper belt portion 82 moving above a lower belt portion 84, a conveyor cavity 85 within which conveyor belt 80 operates, spray wash nozzle(s) 90, a belt scraper 100, a cake collection basin 110, an auger 120, collection manifold 130, a diverter panel 140, and a catch shelf 150. Wastewater inlet 30 is shown at the left in FIG. 2A.

FIG. 2B shows conveyor belt 80 as it moves around lower pulley 205 and carries wastewater 15A on upper belt portion 82 upwardly to the left with filtered water 15B shown dripping through upper belt portion 82 onto diverter pan 170 and flowing through window 172. A lower dam plate 174 prevents filtered water 15B from reaching lower pulley 205 and lower belt portion 84. An upper dam plate 176 is positioned to prevent incoming wastewater 15A, illustrated by a large arrow, from flowing past conveyor belt 80. Cake 15C remains on and within upper belt portion 82 and is carried upwardly.

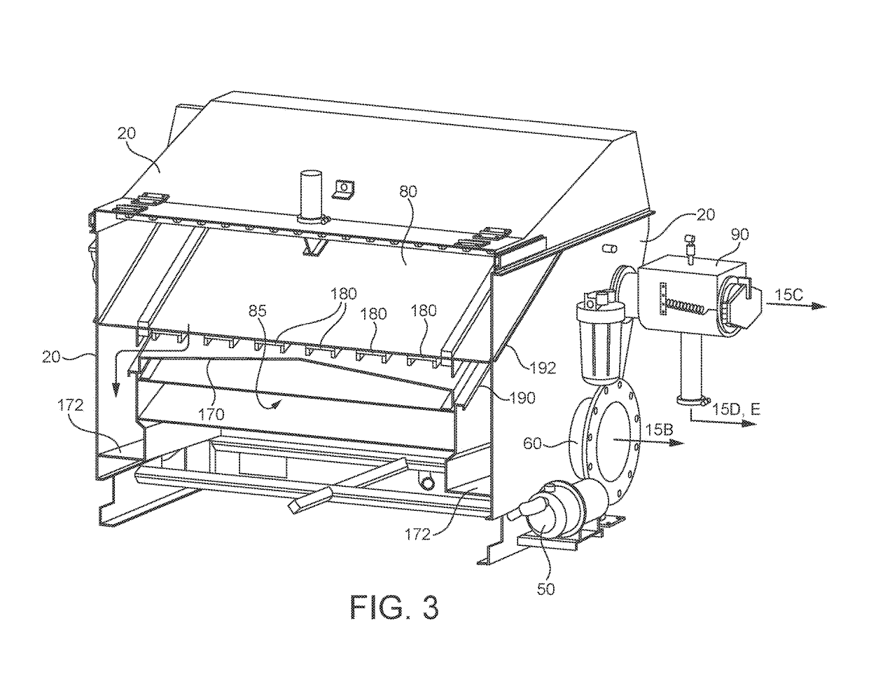

FIG. 3 shows locations of the diverter pan 170 which, for clarity, is not shown in FIG. 2A, framework ribs 180 which support upper belt portion 82, and rubber gasket seals 190 and 192 which constrains filtered water 15B so it can be captured without being contaminated by cake 15A after dribbling onto pan 170. Portions of the enclosure 20, the conveyor belt 80, the conveyor cavity 85, and also the wash water pump 50 and the filtered water outlet 60 are also shown in FIG. 3.

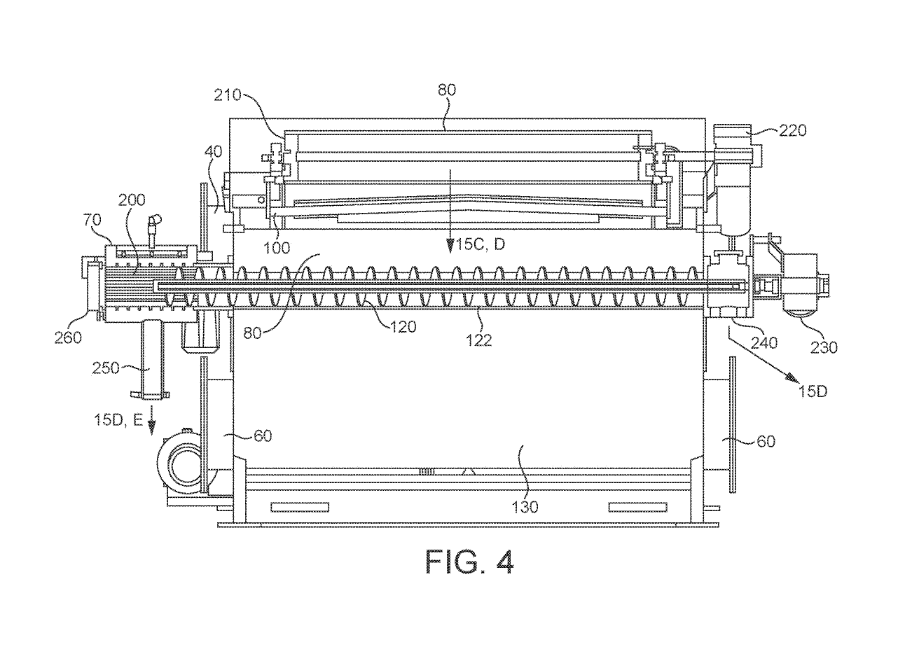

FIG. 4 shows locations of a cylindrical wire cage 200, the top roller 210 which is shown in cross-section, a belt drive 220 of the conveyor belt 80, an auger drive 230, an auger overflow drain 240 for releasing wash water 15D, a dewatering drain 250 for receiving wash water 15D and extracted water 15E, and a compression door 260. FIG. 4 also shows: the wastewater overflow outlet 40, filtered water collection basin 130, filtered water outlets 60, and belt scraper 100.

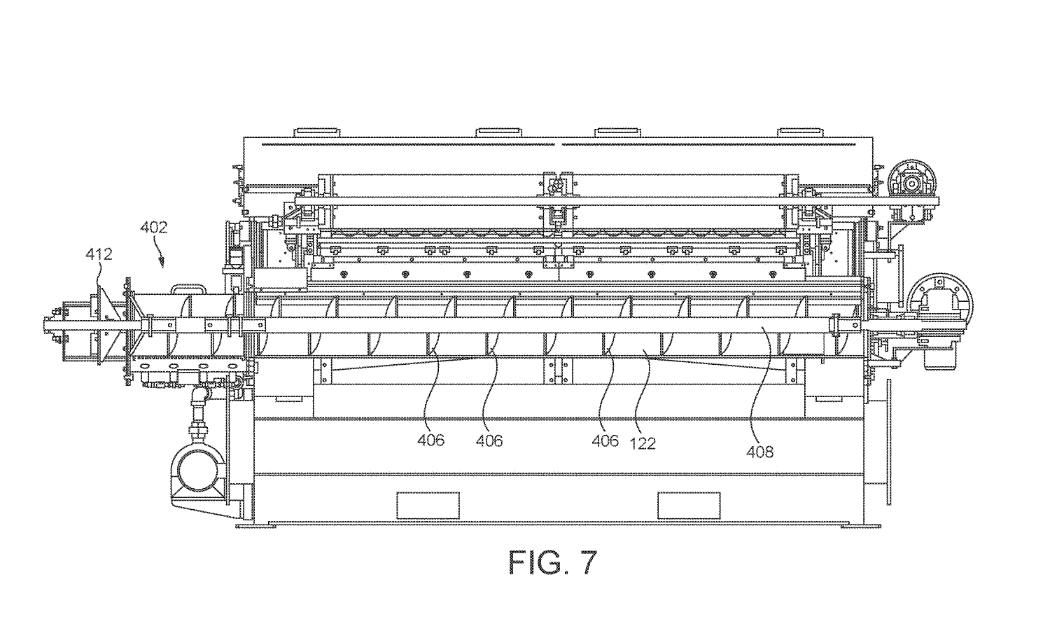

Plant 10 separates and dewaters wastewater 15A entering plant 10 at inlet 30. Wastewater 15A may have a total suspended solids (TSS) in the range of from about 100 to 2,000 mg/L. This wastewater 15A may be collected from a typical municipal sewage system which might have about 300 mg/L TSS. Trash, garbage and other materials usually found in wastewater drainage may be separated using a pre-filter. Downstream of pre-filter wastewater 15A enters plant 10 at inlet 30 where it encounters diverter panel 140 dropping onto catch shelf 150 whereupon it spills onto conveyor belt 80 as shown in FIG. 2B. The diverter panel 140 and catch shelf 150 shown in FIG. 2 direct the incoming wastewater 15A to conveyor belt 80 while absorbing most of its incoming kinetic energy. When the inflow of wastewater 15A is in excess of what belt 80 is able to accommodate, it flows out of wastewater overflow outlets 40 shown in FIG. 1 and into an overflow storage tank 85 shown in FIG. 7 and may be returned to plant 10 later through inlet 30. The conveyor belt 80 is made of a filter mesh material of a fineness selected for capturing a desired degree of the TSS carried by wastewater 15A. Once on conveyor belt 80 wastewater 15A drains by gravity through the top portion 82 of belt 80 and, as shown in FIG. 2, falls onto diverter pan 170 and from there into alleys 172 and collection manifold 130 to then leave plant 10 via outlets 60 as filtered water 15B. Gravity drainage continues during the entire time wastewater 15A rides on belt 80, that is, as belt 80 moves upward.

A cake 15C left behind on and in conveyor belt 80 comprises between 40-90% of the TSS of the wastewater 15A depending on the type and fineness of the filter material of which belt 80 is made. Conveyor belt 80 moves continuously as an inclined rotating linear conveyor. Both upper 82 and lower 84 portions of belt 80 may be planar and may move in parallel with each other in opposite directions and over spaced apart top roller 210 and bottom roller 205 (FIGS. 2A and 2B).

As belt 80 moves over top roller 210 some portion of cake 15C may fall into cake collection basin 110 and therefore into auger screw 120 as best illustrated in FIG. 2. As belt 80 starts to move downward wash water 15D, a high pressure low volume spray is delivered from one or more nozzles 90 against the inside of the lower belt portion 84 of belt 80 where further cake 15C is washed into cake collection basin 110. Subsequently residue of cake 15C is dislodged by scraper 100 and falls into cake collection basin 110 as well. Cake 15C and the wash water 15D is collected in auger screw 120 and conveyed thereby to the wire cage 200 as best shown in FIG. 4, and as described below. Scraper 100 is in position to deflect overspray of wash water 15D into collection basin 110 which may prevent the overspray from entering conveyor cavity 85.

Cake 15C and wash water 15D are carried by auger screw 120 to the left in FIG. 4 into wire cage 200 as described above, where wash water 15D drains into dewatering drain 250. Cake 15C is compacted by auger screw 120 where most of its water content 15E is extracted. Brushes 123 attached to, and extending outwardly from the flights of auger screw 120 keep the approximately 1 mm gaps between adjacent wires of the wire cage 200 clear so that extracted water 15E may flow freely out of wire cage 200 and into dewatering drain 250.

Overflow drain 240, located at the right end of auger screw 120 in FIG. 4 removes excess wash water 15D within auger screw 120 when the level of such water rises high enough to flow around auger flights of auger screw 120 which keeps the screw 120 from flooding.

With the water extraction step described above, cake 15C is converted to a semi-solid consistency which passes out of plant 10 though door 72 when pressure within the wire cage 200 is sufficient to push open door 260 against tension springs. The semi-solid cake 15C may have a water content of between only 50% and 60%.

The auger screw 120 is mechanically rotated within auger trough 122 by an electric auger drive motor 230, as shown in FIG. 4. A further drive 220 of belt 80 is also shown in FIG. 4. As shown, auger trough 122 is open above auger screw 120 so that cake 15C and wash water 15D may freely fall into it from belt 80. Wash water 15D and extracted water 15E may be jointly collected into a common manifold outside of plant 10 and may have between 1500 and 5000 mg/L TSS. There are commercial uses for this water because of its high concentration of biological matter.

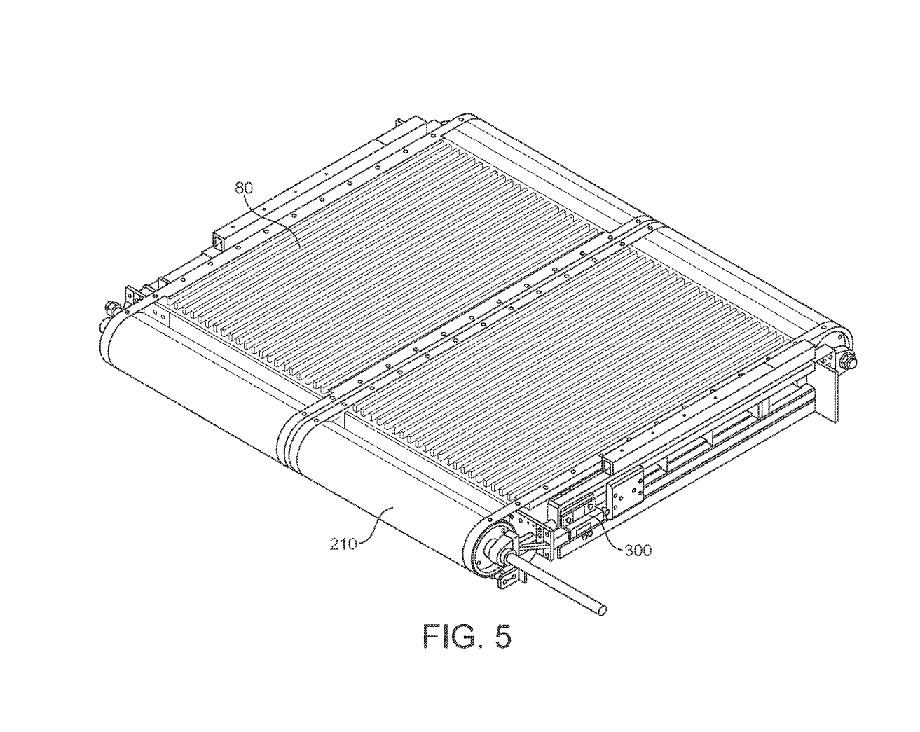

FIG. 5 shows a filter belt 80 having a tensioning apparatus 300 according to an embodiment of the invention. As shown, the tensioning apparatus 300 is provided at the top roller 210 which drives the belt via the belt drive 220 and forms a preload roller assembly. A tensioning apparatus could also (or instead) be provided at the lower roller 205 (which forms a tail roller assembly), if desired.

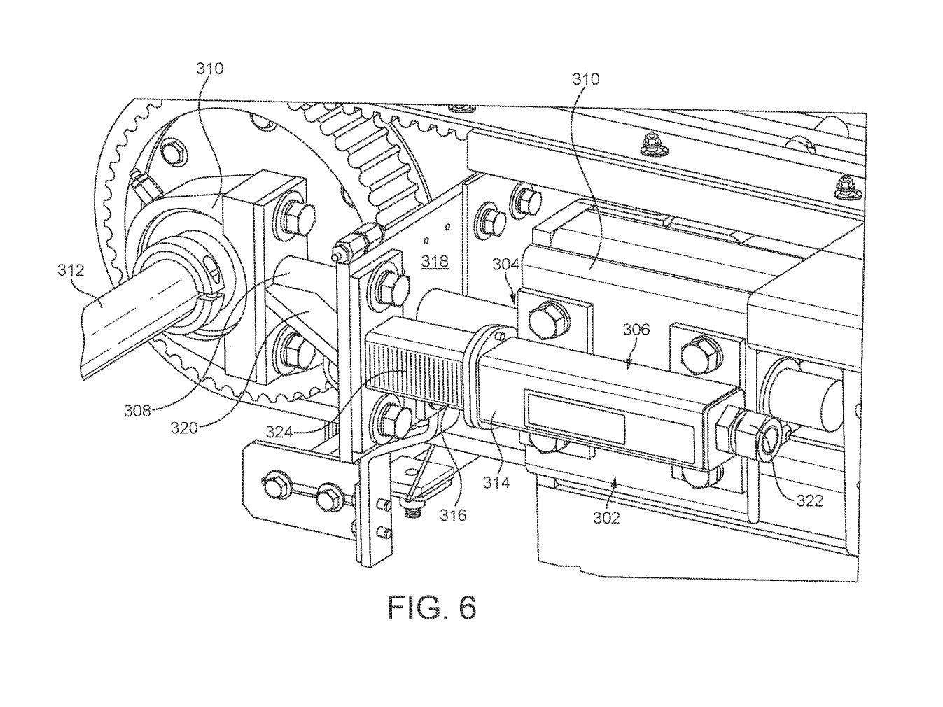

As shown in FIG. 6, the tensioning apparatus 300 comprises a first take-up device 302 which is provided on one side of the filter belt 80. A corresponding, second take-up device (not shown) is provided on the opposing side of the filter belt 80. The first and second take-up devices engage opposing ends of the roller 210. Only the first take-up device 302 will be described below, but the opposing second take-up device has the same form.

The take-up device 302 comprises a non-actuated linear guide 304 and a linear actuator 306.

The linear guide 304 comprises a rod 308 (1¼″ diameter solid stainless steel) and a bearing 310. The rod 308 is slidably supported by the bearing 310 such that it can move linearly relative to the bearing 310. The bearing 310 may comprise a pair of linear non-metallic bushings which are spaced from one another along the longitudinal axis of the guide 304 so as to provide the optimum stiffness and smoothness of motion. The rod 308 is provided with a mounting bracket 311 at its distal end for connecting the rod 308 to a shaft 312 of the roller 210. In this example, the mounting bracket 311 is a pillow block bearing which rotatably couples the rod 308 to the shaft 312, but in other arrangements the shaft 312 may not rotate such that the mounting bracket 311 can fixedly connect to the shaft 312.

The linear actuator 306 comprises a stationary part 314 (stator) and a moving part 316 (pusher). The stationary part 314 forms a body of the actuator 304 and is bolted onto the bearing 310 of the linear guide 304. The moving part 316 is a rod which is bolted at its distal end to a mounting plate 318. The mounting plate 318 connects to the mounting bracket 311 of the linear guide 304 via an arm 320. The moving part 316 is translatable relative to the stationary part 314 via suitable drive means. In the example shown, the linear actuator 306 is a screw-driven actuator which comprises a lead screw that translates the moving part 316 relative to the stationary part 314. The linear actuator 306 comprises an adjuster nut 322 which rotates the lead screw in order to move the moving part 316. The adjuster nut 322 provides a stationary point of actuation of the linear actuator 306 which allows repeated motion with a tool.

The linear guide 304 supports the weight of the roller 210 in a cantilevered manner. The linear guide 304 has sufficient rigidity that it is able to withstand the resulting forces and ensure the roller 210 moves along a linear path. The linear actuator 306 is arranged so that its longitudinal axis is parallel with the longitudinal axis of the linear guide 304. The linear actuator 306 is therefore able to drive the linear guide 304 so as to move the roller 210 between extended and retracted positions.

In the retracted position, the belt 80 is slack such that it can be easily fitted, serviced and removed. In the retracted position, the rod 308 fully penetrates the non-metallic linear bushings of the bearing 310 for 6⅝ inches. With the linear actuator 306 in the extended position, the belt 80 is properly tensioned for operation. A maximum tension of up to 3200 lbs. may be applied by the linear actuator 306 so as to preload the belt 80.

The linear actuator 306 is provided with an incremental measurement scale 324 which defines the position of the moving stationary part 316 relative to the stationary part 314. As described previously, the belt 80 is provided with two take-up devices, one on each side of the belt 80. The scale 324 on each side provides a visual indication of how far the take-up device has been extended or retracted. By matching each scale to the same value, the tracking of the belt 80 can be accurately and repeatably set with no external tooling. Tracking refers to how straight a belt travels over two rollers. If one piston is extended further than the other, the belt will want to travel towards the tighter piston. This can lead to potential failure and/or damage of the filtration belt assembly. This tensioning system provides a more accurate and repeatable method of applying equal force across the entire width of the belt 80. The individual take-up devices provide visually measureable positioning to easily adjust belt tracking within 1.5 mm (0.06″). These measurements can be documented and plotted over time, aiding in the prediction of service interval and/or life of the filtration belt assembly.

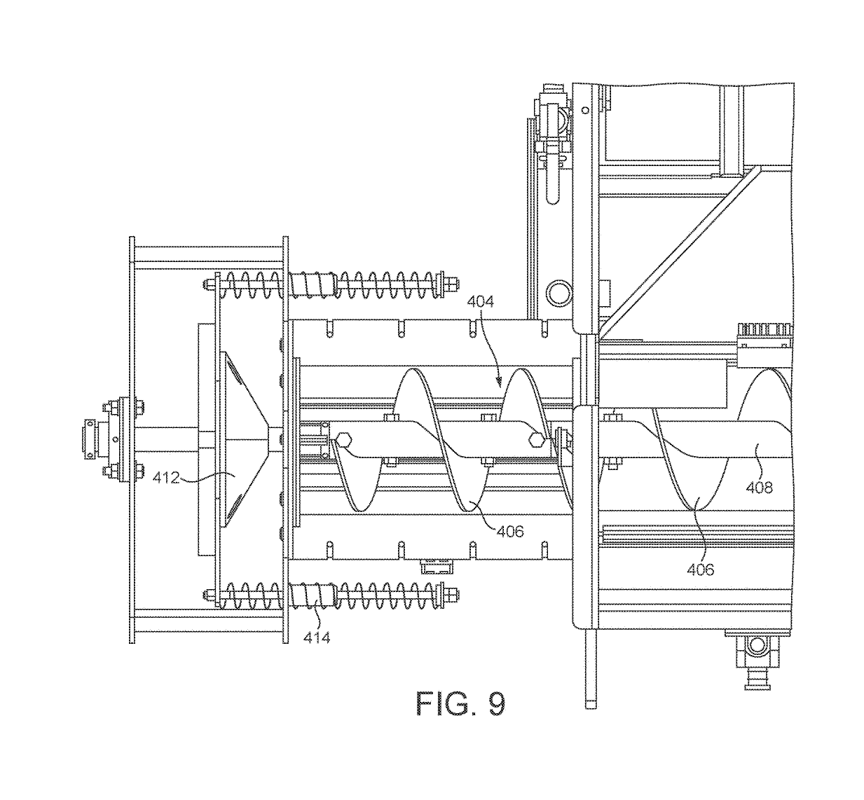

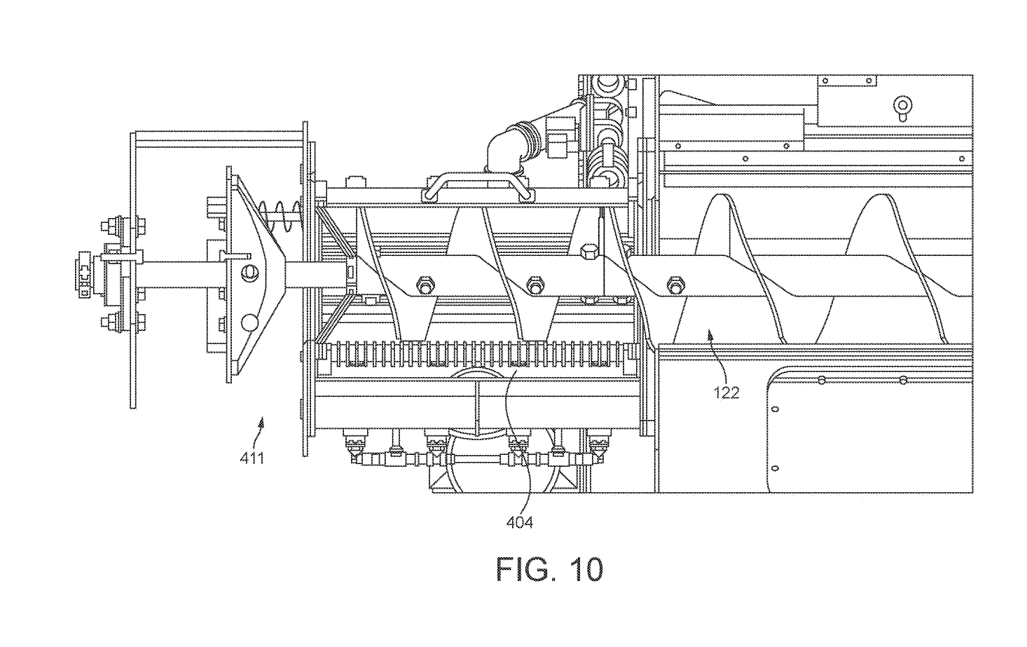

FIGS. 7 to 10 show a modified outlet section for the screening apparatus described previously which comprises a different dewatering arrangement. In this arrangement, the auger screw 120 extends the entire length of the trough 122 and into the compression chamber 402.

The bottom of the compression chamber 402 has a structural wedge wire screen 404, allowing the compressed water to filter through for discharge.

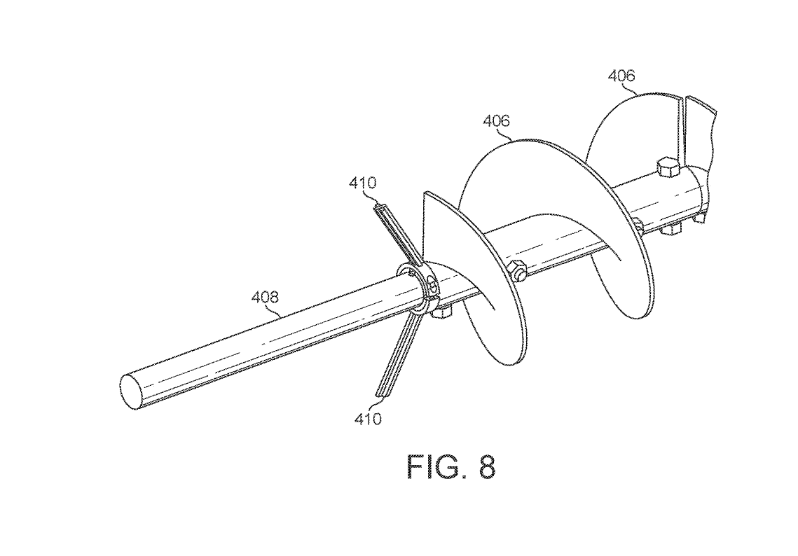

The auger screw 120 in the compression chamber 402 covers 80% of the wedge wire surface. In this example, the auger screw comprises a shaft 408 on which a helical blade 406 is formed. The blade 406 has a 9″ diameter (right hand) and a 9″ pitch over its length within the trough 122. Once inside the compression chamber 402, the helical blade 406 reduces to ¾ pitch so as to compress the solids. As shown in FIG. 8, mixing blades 410 are provided on the shaft 408 at an outlet portion downstream of the blade 406. As shown, the mixing blades 410 comprise two diametrically opposed blades which extend radially from the shaft 408, although other arrangements may be used.

The solids continue to be compressed as they transfer through the compression chamber 402 until they reach the mixing blades 410. The mixing blades rotate with the shaft 408, cutting through the concentrated dewatered solids mass.

The outlet 411 of the compression chamber 402 comprises a discharge cone 412. In the example shown, the discharge cone 412 has a 60° solid angle surface. The discharge cone 412 is translatable relative to the compression chamber 402 to provide an outlet out of the compression chamber 402 (of up to 8″ in area), but is biased towards the compression chamber 402 (i.e. towards a closed position) by two spring-biased compression pistons 414 that provide balanced force and precise motion.

The mixing blades 410 break up the solids mass as it begins to be forced out of the discharge cone 412. Breaking up the solids mass provides two benefits. The solid mass is separated, freeing any trapped water inside the solid mass and maintaining equal distribution of the solids around the discharge cone 412. Maintaining the equal distribution of solids around the discharge cone is critical in having uniform compression in the compression chamber 402. The solids are forced against the surface of the discharge cone 412, discharging the solids 360° around the cone. The cone force can be adjusted to provide a linear force from 0 lbs. to 67.2 lbs., giving up to 1.11 psi.

Although the tensioning apparatus has been described with reference to a wastewater screening apparatus, it will be appreciated that it may be applied to any belt conveyor.

1-12. (canceled)

13. A tensioning apparatus for a belt conveyor, the tensioning apparatus comprising:
first and second take-up devices configured to engage opposing ends of a roller of the belt conveyor, wherein each take-up device includes:
a linear guide including a rod and a bearing which slidably supports the rod for linear movement of the rod relative to the bearing, wherein the rod includes a mounting bracket at or towards its distal end for connecting to a shaft of the roller; and
a linear actuator including: a stationary portion coupled to and stationary with respect to the bearing of the linear guide, a moving portion coupled to the mounting bracket of the linear guide, and drive means for moving the moving portion relative to the stationary portion such that the rod of the linear guide slides relative to the bearing.

14. A tensioning apparatus as claimed in claim 13 wherein the mounting bracket is a pillow block bearing which is configured to rotatably support the roller.

15. A tensioning apparatus as claimed in claim 13, wherein the linear actuator is a screw-driven actuator.

16. A tensioning apparatus as claimed in claim 13, wherein at least one of the linear actuator and the linear guide includes a measurement scale for determining the position of the roller.

17. A tensioning apparatus as claimed in claim 13, wherein the linear guide supports the shaft of the roller in a cantilevered manner.

18. A wastewater screening apparatus comprising:
a tensioning apparatus as claimed in claim 13.
